(19) United States
(12) Patent Application Publication
(10) Pub. No.: US 2025/0308140 A1
(43) Pub. Date: Oct. 2, 2025

(54) IMAGE PROCESSING TRAINING SET GENERATION

(71) Applicant: Florida Power & Light Company, Juno Beach, FL (US)

(72) Inventors: Jack P. ABRAMS, Juno Beach, FL (US); Stephen S. CROSS, North Palm Beach, FL (US); Mackenzie VECCHIO, Boca Raton, FL (US); Kyle A. BUSH, Palm Beach Gardens, FL (US); Paul R. HYNES, Jupiter, FL (US); Eric D. SCHWARTZ, Palm Beach Gardens, FL (US)

(21) Appl. No.: 18/624,677

(22) Filed: Apr. 2, 2024

(51) Int. Cl. G06T 15/20; G06T 15/06

(52) U.S. Cl. CPC G06T 15/20; G06T 15/06; G06T 2210/21

(57) ABSTRACT

Systems and methods for defining bounding polygons in a view of a three-dimensional scene. Rays are defined that each extend from a viewpoint of a virtual three-dimensional model to a vertex of an object of interest in the virtual three-dimensional model. A set of occluded rays is determined that include rays intercepting occluding objects in the virtual three-dimensional model prior to reaching a vertex of the object of interest when extending from the viewpoint. A set of visible rays is defined with respect to the object of interest that excludes the occluded set of rays. A bounding polygon for the object of interest that encompasses each vertex intercepted by the set of visible rays and excludes at least one vertex intercepted by a respective ray in the set of occluded rays is defined in an image of the virtual three-dimensional model that is created from the viewpoint.

### FIELD OF THE DISCLOSURE

The present disclosure generally relates to creating data sets that are suitable for training automated image recognition processes, and more particularly to producing sets of image recognition training images based on three-dimensional computer models.

### BACKGROUND

Automated systems that support and perform computer vision and image recognition, such as those that include artificial intelligence (AI), machine learning processing, can be provided with an image of an object of interest and identify the object that is in the image. Such processing is useful for automatically identifying or classifying the object or objects that are captured in each of a large number of images.

In some examples, automated artificial intelligence based image recognition processes are initially trained to recognize particular objects by providing training data sets to train the image recognition model. Such training data sets include a number of images of objects that the machine learning system is to identify. Training of the machine learning based image recognition process is able to be aided with annotations of the images by labeling the object in training images to more efficiently direct the training process. Such labeling is able to include metadata that identifies the type of object that is in the image (e.g., a description) and may also highlight or otherwise indicate the labeled object in some way to facilitate the machine learning algorithm in identifying the object.

Creating training data sets to be used to train machine learning based image recognition processes can be a resource intensive task. Effective training uses a large number of images of a particular object where the images have different views of that particular object effectively captured from many different angles and distances. A training image data set is also able to include images of a particular object with different backgrounds, other objects in proximity to the particular object, have other features or characteristics, or combinations of these. Creation of a training data set of images can include a labor intensive task of identifying and demarcating the particular object of interest in each of the often many images in that training data set.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates an image recognition training and processing system, according to an example;

FIG. 2 illustrates a three-dimensional model top view, according to an example;

FIG. 3 illustrates a first annotated image, according to an example;

FIG. 4 illustrates a second annotated image, according to an example;

FIG. 5 illustrates an annotated image set generation process, according to an example;

FIG. 6 illustrates a bounding polygon definition process, according to an example;

FIG. 7 illustrates a bounding polygon creation process, according to an example; and

FIG. 8 illustrates a block diagram illustrating a processor, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below systems and methods include and provide processing and techniques to facilitate the creation of a training data set for training of a machine learning based image recognition process. The below described systems and methods operate to create a training data set to train a machine learning based image recognition process to recognize a particular object in an image where that image of the particular object is able to present a view of that object from any angle, capture orientation, distance, or combinations of these. In the following description, the term viewpoint is used to describe a position in three-dimensional space relative to an object from which a view of that object is captures.

The below described systems and methods create a number of images of a particular object within one or more scenes where each image captures a view of that particular object from a different viewpoint. In some examples, various scenes are created that present the particular object in proximity to other objects that are able to obscure or occlude the view of part of the particular object from some viewpoints.

In some examples, the below described systems and methods receive a definition of a computer generated, virtual, three-dimensional model of a scene that includes the particular object that the machine learning based image recognition process is to be trained to recognize. In some examples, the scenes defined by these computer generated virtual three-dimensional models also include other objects located in proximity to the particular object, other objects that obscure of occlude views of the particular object from some viewpoints, other objects in the scene, various background scenes, or combinations of these. The below described systems and methods process these definitions of computer generated three-dimensional models to create two-dimensional views of the scene defined within these three-dimensional models. In some examples, the two-dimensional views are two dimensional projections of the scene as captured from a number of viewpoints around the particular object.

Due to the other objects also contained within the computer generated virtual three-dimensional models, a particular object is able to be obscured by other objects in the scene. The robustness of an image recognition process is increased by training such a process with views of the particular object to be recognize that have that particular object partially obscured by other objects in the scene. Using automated processes to create such views, such as by processing a computer generated definition of a virtual three-dimensional scene, greatly increases the efficiency and reduces the cost of creating such a large number of images depicting views with occlusions of the object to be identified.

In an example, the computer defined three-dimensional models include the particular object to be recognized along with other objects in the scene that are sometimes installed with or in proximity to that particular object in the real world. In an example of processing images of equipment deployed in electric utility infrastructures, an electrical power distribution pole is able to have one or more transformers, overcurrent protection devices, monitoring equipment, other equipment, or combinations of these, mounted adjacent to each other near the top of a single power distribution pole.

In order to facilitate training of a machine learning based image recognition process in some examples, bounding polygons, such as quadrilateral bounding boxes, are defined for each object of interest in the created view of the scene. Such bounding polygons are defined for the captured view according to processes described below.

In general, bounding polygons are used to annotate each object of interest that is depicted in an image where a person can discern that object. In an example, the processes described below determine how much of the depiction of an object of interest is occluded in the image and bounding polygons are only defined for objects of interest with visibility characteristics in the image that meet a specific threshold. In some examples, the threshold is defined as a percentage of vertices of that object that have unobstructed rays, i.e., the percentage of vertices of that object that are visible in the image. In an example, bounding polygons are defined for objects of interest that is more than fifty (50) percent visible in that view.

In some examples, bounding polygons are created by drawing a polygon that encompasses the maximum extent of the vertices that correspond to unobstructed rays if the number of unobstructed rays, and thus the number of visible vertices, is above a threshold. In some examples, a bounding polygon is crated to encompass only the major visible portions of an object of interest. In some examples, a bounding polygon referred to in some examples as a bounding box that is in the form of a rectangle is defined as an annotation indicating an object of interest. In further examples, a bounding polygon is defined by a polygon with three or more sides instead of a quadrilateral box to more effectively outline the visible portions of the object of interest.

In general, bounding polygons are able to be defined according to any suitable technique. In some examples, bounding polygons are defined as metadata and such bounding polygons are not explicitly depicted in the image of the view being annotated. In further examples, a bounding polygon is able to be depicted on the image by any suitable technique.

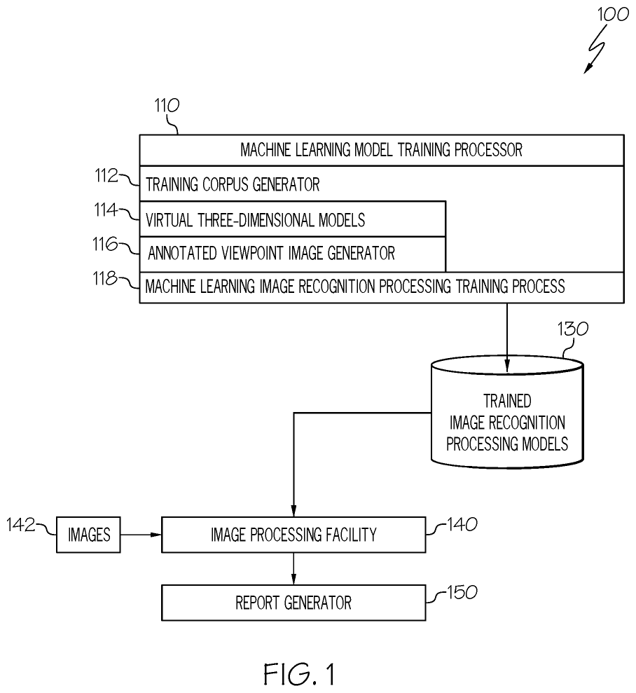

FIG. 1 illustrates an image recognition training and processing system 100, according to an example. The image recognition training and processing system 100 depicts an example of a system that facilitates the creation of a training corpus for a machine learning based image recognition process. Such a training corpus is able to include one or more datasets that are used to train machine learning based image recognition processes, and uses that created training corpus to train a machine learning based image recognition process. In some examples, a trained machine learning based image recognition process is used to process captured images and provide indications of objects of interest that the process identifies in those images.

The image recognition training and processing system 100 includes a machine learning model training processor 110 that has a training corpus generator 112 and a machine learning image process training process 118. The training corpus generator 112 is an example of a processor that creates images that are used to train a machine learning based image recognition process. The machine learning image process training process 118 of the machine learning model training processor 110 trains various machine learning image processes by using the images created by the annotated viewpoint image generator 116.

In some examples, the training corpus generator 112 creates a number of images that capture views of scenes that include objects of interest, where those objects of interest are objects whose presence is to be recognized by a machine learning based image recognition process that is trained with those images. In an example, some or all of the images created by the training corpus generator 112 are annotated to indicate which pixels in each image contain images of a particular object of interest.

The training corpus generator 112 in an example includes definitions of virtual three-dimensional models 114 that represent scenes including representations of one or more objects of interest arranged around other objects that can exist in proximity to each other at various real locations. In some examples, the virtual three-dimensional models include representations of objects of interest that are in good condition, are damaged versions of the object of interest, or both, in order to broaden the variations of the appearances of objects of interest that a trained machine learning based image recognition process is able to recognize.

The representations of the virtual three-dimensional models 114 are able to be created, stored, accessed, otherwise processed, or combinations of these, by any suitable technique. In an example, three-dimensional modelling software is able to have virtual three-dimensional representations of real world objects, such as a pole mounted electrical transformer installed by an electric utility, defined and stored by any suitable technique. One or more scenes are able to be defined by combining a number of such virtual three-dimensional object representations into a scene.

In some examples, scenes in virtual models are created by assembling a number of virtual three-dimensional object representations with specified spatial relationships among those virtual objects. For example, a scene of an installation of electric utility equipment is able to be created by specifying the location of various pieces of equipment and other objects that are found in such an installation along with the three-dimensional representation of each of those pieces of equipment and other objects, such as trees and the like. In some examples, such virtual three-dimensional representations of objects and the entire scene are stored as data so that the systems and processing of the below described systems are able to create datasets that define these virtual three-dimensional models without physically constructing these models.

The training corpus generator 112 further has an annotated viewpoint image generator 116. The annotated viewpoint image generator 116 in an example processes the data defining the virtual three-dimensional representation of scenes, including the objects within the scenes, to create images of those scenes from a number of viewpoints. In an example, each image created by the annotated viewpoint image generator 116 is a two dimensional projection to a specified respective viewpoint of the virtual three-dimensional scene defined by a virtual three-dimensional model within the virtual three-dimensional models 114. A viewpoint in this context generally has an associated point in virtual three-dimensional space relative to the virtual three-dimensional model and also has a view angle from that point. In general, the view angle is an angle that includes at least part of a scene defined in the virtual three-dimensional model.

The annotated viewpoint image generator 116 further annotates the created images to indicate the location of objects of interests in the created image. Annotations are to be broadly understood to include any indication of a representation of a specified object in an image where that indication is able to be specified and associated with the image in any suitable way. In some examples, an annotation is able to include one or more of a bounding polygon associated with the image that encompasses the specified object, a label identifying the specified object, other annotations according to the use of the image for training of a machine learning based image recognition process, or combinations of these.

Bounding polygon in various examples are able to be defined as coordinates in the image that may or may not be visually represented in the image, defined and stored in association with the image by any suitable technique, or combinations of these. In various examples, a bounding polygon is able to comprise a bounding box, which is a bounding polygon with four sides, a bounding polygon with more or less than four sides, or a polygon with any arrangement of any number of sides. In some examples, a bounding polygon is able to be constructed by forming a number of sub-polygons that connect various vertices of images of an object in an image. In some examples, a bounding polygon for an object of interest is able to indicate an area of an image that includes the object of interest as well as areas of the image surrounding the object of interest, i.e., it is able to be larger than the image of the object of interest. In some examples, a bounding polygon is able to be smaller than the image of the object of interest due to, for example, occlusion of the object of interest in the image being annotated. In general, a bounding polygon is able to have any shape and size that can be used to adequately indicate an object of interest in an image given the use of that image and its annotations. As described in further detail below, some examples are able to efficiently determine which regions of an image to annotate based on ray tracing processing performed on the virtual three-dimensional models of the scene represented in the image being annotated.

The created annotated viewpoint images are provided to the learning image processing training process 118 of the machine learning model training processor 110 to be used to train various machine learning image processes. In various examples, such training is able to be performed by any suitable technique either known now or in the future. The machine learning image processing training process 118 produces one or more trained image recognition processing models 130 that are able to be provided to various image processing facilities 140.

Image processing facilities 140 receive images 142 from any source and processes those images in conjunction with one or more of the trained image recognition processing modules 130 to identify objects of interest in those images. The objects of interest that the image processing facility is able to identify is based on the training corpus used to train the trained image recognition processing model 130. The image processing facility 140 in an example provides indications to a report generator 150 of identified objects in the received images 142. In various examples, reports generated by the report generator are able to include identifications of objects recognized in received images 142. For example, a trained image recognition processing model 130 is able to be trained to recognize that an image contains an object that is identified as an operational piece of equipment or an object that is identified as a damaged version of the piece of equipment. Based on identifying the piece of equipment as operational or damaged, the report generator is able to report that the piece of equipment in the received image 142 is operational or should be inspected for repairs.

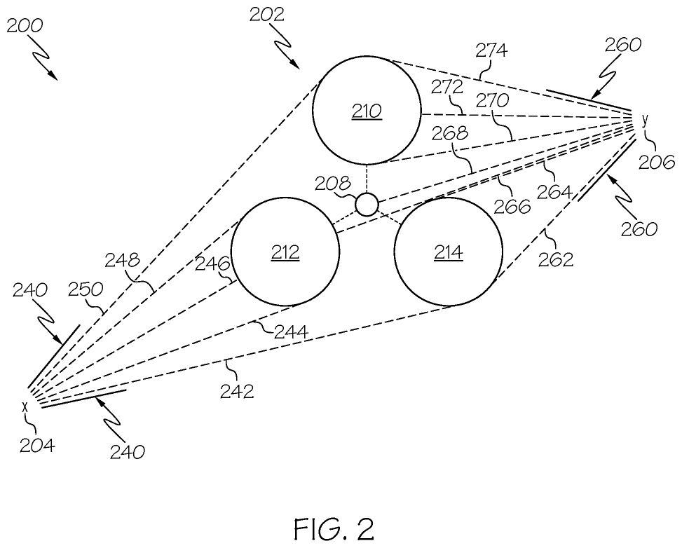

FIG. 2 illustrates a three-dimensional model top view 200, according to an example. The three-dimensional model top view 200 in a visualization of an example three-dimensional computer generated model. The three-dimensional model top view 200 presents a top view of a scene 202 that consists of a power pole 208 onto which are mounted three (3) pole mounted transformers, a first pole mounted transformer 210, a second pole mounted transformer 212, and a third pole mounted transformer 214. The presented visualization in an example corresponds to a digitally defined virtual three-dimensional model such as is described above with regards to the virtual three-dimensional models 114. Such a virtual three-dimensional model is able to be created in an example by three-dimensional modelling software based on a specified arrangement of components in the model. In the illustrated example, a specification that three pole mounted transformers are attached to a pole in the illustrated manner is able to be provided to the three-dimensional modelling software by any suitable technique, such as by an operator's input.

The three-dimensional model top view 200 further presents two (2) viewpoints, a first viewpoint “X” 204 and a second viewpoint “Y” 206. A view of the scene 202 from each of these viewpoints is able to be created by any suitable technique. A view of the scene 202 captured from the first viewpoint “X” 204 has a first field of view 240 and the second viewpoint “Y” 206 has a second field of view 260. As depicted for the three-dimensional model top view 200, the first field of view 240 and the second field of view 260 both capture the entirety of the scene 202. Some objects in the scene 202 that are within the field of views for these two viewpoints, however, are obscured, or occluded, by other objects in the scene 202 that are between the occluded object and the viewpoint.

For example, images of the scene 202 that are captured or created from the first viewpoint “X” 204 have parts of the pole 208 that are at the same level as the second transformer 212 occluded by the second transformer 212. Such an image from the first viewpoint “X” 204 will also have portions of the first transformer 210 and the third transformer 214 occluded by the second transformer 212.

In some examples, the below described systems and methods create images of views of the scene 202 by processing computer data that defines the virtual three-dimensional model of the scene 202. These examples further operate to efficiently process the data defining the virtual three-dimensional model of the scene 202 to, for example, automatically provide bounding polygon around images of objects of interest in the scene 202, automatically label such objects of interest that are visible in the view of the scene 202, perform other processing to facilitate using such images for training of machine learning based image recognition processing, or combinations of these.

In some examples, processing of data defining a virtual three-dimensional model of the scene 202 is used to create an image of a view from a particular viewpoint. The creation of such an image is able to be performed by any suitable technique. In order to efficiently provide bounding polygon, labels, other annotations, metadata, or combinations of these, some examples of the below described systems and methods utilize ray tracing to determine which parts of objects in the scene 202 are visible from a particular viewpoint, and which parts of objects in the scene 202 are occluded from that particular viewpoint by other objects in the scene 202.

The three-dimensional model top view 200 depicts a number of rays that are used by processing to determine which portions of objects that are visible and which portions are occluded from a particular viewpoint. In an example, each of these rays are conceptually created by processing of data defining the virtual three-dimensional model of the scene 202 to define a straight line path from a viewpoint of the virtual three-dimensional model into its corresponding field of view and on to a corresponding destination that is a vertex of the first object in the scene 202 that the line defining that ray encounters. In an example, such lines are not actually drawn but are definitions of conceptual lines created by processing of the data defining the virtual three-dimensional model of the scene 202.

In these examples, processing is able to efficiently determine that a view of the scene 202 includes the first object encountered by the ray along the angle that the ray projects from the view angle, and other objects in the scene 202 that are at the angle that the ray projects are not visible because they are occluded by the first object encountered by that ray. Such processing for pixels in an image of a view from a viewpoint facilitates efficient labeling of objects visible in an image and not including annotations, such as bounding polygon, for parts of object occluded by other objects in the scene 202.

The first viewpoint “X” 204 shows a number of rays originating from the first viewpoint “X” 204 and projecting into the first field of view 240. Although the three-dimensional model top view 200 depicts a two-dimensional representation of the scene 202, in some examples the processing of the below described systems and methods extends rays in three-dimensions to fill both the elevation angle of view and the horizontal angle of view of the first field of view 240. Defining the depicted rays originating from the first viewpoint “X” 204, such as by processing of the virtual three-dimension model defining the scene 202, is an example of defining a plurality of rays with each ray extending from a viewpoint of a virtual three-dimensional model to a respective vertex in a plurality of destinations that are at vertices of a virtual three-dimensional representation of an object of interest in the virtual three-dimensional model.

A first ray 242 extends from the first viewpoint “X” 204 to a point on the third transformer 214. The point where a ray intercepts an object in a virtual three-dimensional model is referred to herein as a vertex. In various examples, a vertex is able to be in the middle of an object as seen from the viewpoint or on an edge of the object as seen from the viewpoint. Edges of objects are able to be determined by any suitable technique, such as by processing of the data defining the virtual three-dimensional model. This characteristic allows the processing of data defining the three-dimensional model of the scene 202 to efficiently determine that the edge of the third transformer is visible from the first viewpoint “X” 204 and is not occluded by another object. A second ray 244 extends from the first viewpoint “X” 204 to an edge or vertex of the second transformer 212. Because the second ray 244 intercepts the second transformer 212 before it reaches a vertex of the third transformer it does not extend to the third transformer 214. Determining these relationships allows efficiently determining that an image of the scene 202 from the first viewpoint 204 includes images of the third transformer 214 between the angles of the first ray 242 and the second ray 244 and that a bounding polygon, label, other annotation, or combinations of these, is able to be assigned to that portion of the image of the scene 202 created for the first viewpoint “X” 204.

A third ray 246 extends from the first viewpoint “X” 204 to a vertex at the middle of the second transformer 212 and a fourth ray 248 extends to another edge or vertex of the second transformer 212. The characteristics of the second ray 244, the third ray 246, and the fourth ray 248 allows the processing of data defining the virtual three-dimensional model of the scene 202 to efficiently determine that the second transformer 212 is visible from the first viewpoint “X” 204 and is not occluded by another object. This also indicates that other objects in the direction of the second ray 244, the third ray 246, and the fourth ray 248, such as the pole 208 and portions of the first transformer 210 and the third transformer 214, are occluded by the second transformer 212 and that annotations, such as bounding polygon, labels, other annotations, or combinations of these, would be restricted in the direction of rays between the second ray 244 and the fourth ray 248.

A fifth ray 250 extends from the first viewpoint “X” 204 to an edge of the first transformer 210. Rays at angles between the fourth ray 248 and the fifth ray 250 will first intercept the first transformer 210 and annotations, such as bounding polygon, labels, other annotations, or combinations of these, at these angles indicate the first transformer 210.

In the above described example, the second ray 244 is referred to as an occluded ray with regards to the third transformer 214. The second ray 244 is thus in a set of occluded rays with regards to the third transformer 214 because it intercepts the second transformer 212, which is an occluding object with regards to the third transformer 214 in this example, prior to reaching a vertex of the third transformer. The second ray 244 is also referred to as a visible ray with regards to the second transformer 212.

The second ray 244, third ray 246, and fourth ray 248 are examples of a second plurality of rays that each extend from the first viewpoint “X” 204 to a respective vertex in of a virtual three-dimensional representation of the second transformer 212. The second transformer is an occluding object with respect to the first transformer 210 and the third transformer 214. Based on the second ray 244 and the fourth ray 248 extending to an edge of the second transformer, and rays between the second ray 244 and the fourth ray 248 are occluded rays with regards to the first transformer 210 and the third transformer 214, the second ray 244 is able to be determined as intercepting a vertex on an edge of the second transformer 212 that divides the image of the second transformer 212 and the third transformer 214. As is described in further detail below, a bounding polygon for the third transformer is able to be annotated on a created image from the first viewpoint “X” 204 that has a side defined by that edge between the second transformer 212 and the third transformer 214 that has a vertex corresponding to the second ray 244.

The second viewpoint “Y” 206 also shows a number of rays originating from the second viewpoint “Y” 206 and projecting into the second field of view 260. A sixth ray 262 extends from the second viewpoint “Y” 206 to an edge of the third transformer 214 and a seventh ray 264 extends from the second viewpoint “Y” 206 to the other edge of the third transformer 214. This characteristic allows the processing of data defining the three-dimensional model of the scene 202 to efficiently determine that the third transformer 214 is visible from the second viewpoint “Y” 206 and is not occluded by another object. Thus, the portion of an image from the second viewpoint “Y” 206 is able to have a bounding polygon, label, other annotation, or combinations of these associating the third transformer 214 between the sixth ray 262 and the seventh ray 264. Further, other objects along the direction of the sixth ray 262 and the seventh ray 264, such as part of the second transformer 212, are occluded and thus not visible in that image and cannot have bounding polygon, labels, or other annotations between the angles of those two rays.

An eight ray 266 extends from the second viewpoint “Y” 206 to the second transformer 212. This indicates that the second transformer 212 is visible in an image from the second viewpoint “Y” 206 at angles between the angle of the seventh ray 265 and the eight ray 266 and a bounding polygon, label, other annotation, or combinations of these can be associated with pixels corresponding to angles between the seventh ray 264 and the eight ray 266.

A ninth ray 268 extends from the second viewpoint “Y” 206 to the pole 208. This indicates that the pole 208 is visible in an image from the second viewpoint “Y” 206 at the angel of the ninth ray and pixels corresponding to that angle are able to be within a bounding polygon, label, other annotation, or combinations of these. Objects in the scene 202 that are beyond the pole 208, such as a portion of the second transformer 212, are not visible in an image from the second viewpoint “Y” 206 and thus cannot be associated with pixels corresponding to the angle of the night ray 268.

A tenth ray 270, an eleventh ray 272, and a twelfth ray 274 extend from the second viewpoint “Y” 206 to portions of the first transformer 210, thus indicating that pixels corresponding to angles of these rays are able to have a bounding polygon, label, other annotation, or combinations of these, to indicate the presence of the first transformer 210.

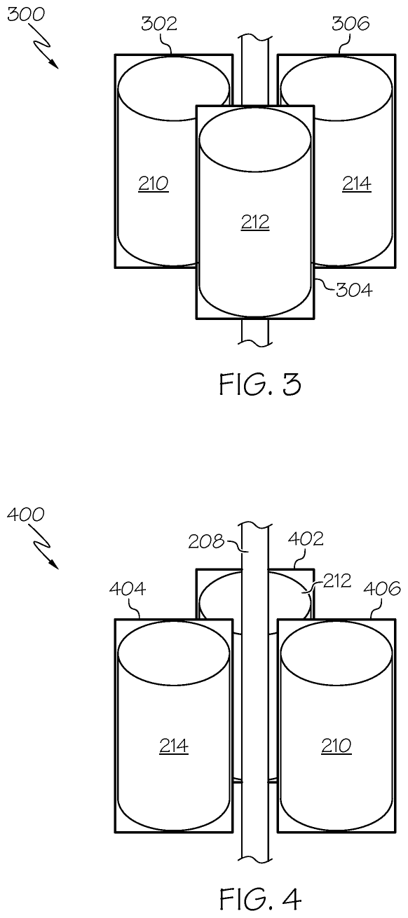

FIG. 3 illustrates a first annotated image 300, according to an example. With reference to the above described three-dimensional model top view 200, the first annotated image 300 is an example of an image created of the scene 202 from the first viewpoint “X” 204. As noted above, a view of the scene 202 from the first viewpoint “X” 204 has a view of the second transformer 212 without occlusions and a view of part of each of the first transformer 210 and the third transformer 214 with the other parts of those transformers occluded by the second transformer 212.

The bounding polygon of the first annotated image 300 are depicted as being separated from the edges of objects of interest in order to make the depicted bounding polygon more visible in the drawings. In some examples, bounding polygon are able to be defined along the visible edges of an object of interest to more precisely depict the extent of the edges of the objects of interest, while in further examples such bounding polygon are able to be separated from the image of the object of interest and enclose an area greater than the image of the object of interest. As noted above, bounding polygon are able to be defined, as stored in association with the image, but not depicted on the annotated image itself.

The first annotated image 300 has a first bounding polygon 302 indicating the second transformer 212. The first bounding polygon 302 is shown to conform around the edge of the second transformer 212 where the view of the first transformer 210 is occluded by the second transformer 212. In an example, the outline of the bounding polygon is determined by pixels in the image that correspond to rays extending from the first viewpoint “X” 204 that intercept edges of the second transformer 212.

The first annotated image 300 has a second bounding polygon 304 indicating the second transformer 212. The second bounding polygon 304 is shown to encompass the visible portion of the first transformer 212 that is not occluded by the second transformer 212 and thus conforms to the edge of the second transformer 212 at the boundary of the occlusion from the first viewpoint “X” 204. In an example, the outline of the bounding polygon is determined by pixels in the image that correspond to rays extending from the first viewpoint “X” 204 that intercept the first transformer 210 without first intercepting any other object in the scene 202.

The first annotated image 300 also has a third bounding polygon 306 indicating the third transformer 214. The third bounding polygon 306 is shown to conform around the edge of the second transformer 212 where the view of the third transformer 214 is occluded by the second transformer 212. In an example, the outline of the bounding polygon is determined by pixels in the image that correspond to rays extending from the first viewpoint “X” 204 that intercept the first transformer without first intercepting the third transformer 214. As discussed above, the third bounding polygon 306 has a side that includes an edge that divides the second transformer 212 and the third transformer 214 where that edge was determined by processing of rays to determine which rays intercept vertices of different objects in the scene 202.

FIG. 4 illustrates a second annotated image 400, according to an example. With reference to the above described three-dimensional model top view 200, the second annotated image 400 is an example of an image created of the scene 202 from the second viewpoint “Y” 206. As noted above, a view of the scene 202 from the second viewpoint “Y” 206 has a full view of the first transformer 210 and the third transformer 214 without occlusions and a view of a part of the second transformer 212 with parts of the second transformer 212 occluded by the other transformers and the pole 208. As noted above, bounding polygon depicted in the second annotated image 400 are separated from the edges of the objects of interest they indicate in order to better depict the bounding polygon in the drawings.

The second annotated image 400 has a second bounding polygon 404 and a third bounding polygon 406 that indicate the third transformer 214 and the first transformer 210, respectively. As noted above, the view of the scene 202 from the second viewpoint “Y” 206 has an unobstructed view of the first transformer 210 and the third transformer 214 so those elements appear in the second annotated image 400 without occlusions. The lack of occlusions is determined by processing of the three-dimensional model data to determine that rays that originate from the second viewpoint “Y” 206 with angles between the sixth ray 262 and the seventh ray 264, for the third transformer 214, and with angles between the tenth ray 270 and the twelfth ray 274, for the first transformer 210, do not intersect other objects in the scene 202 before encountering those transformers. The second bounding polygon 404 is shown to conform around the edge of the first transformer 210 and the third bounding polygon 406 is shown to conform around the edge of the first transformer 210.

The second annotated image 400 includes the pole 208. In the illustrated example, the pole 208 is not an element that a machine learning based image recognition process is trained to recognize. Due to the pole 208 not being an object of interest for training a machine learning based image recognition process, no annotation, such as a bounding polygon, label, other annotation, or combinations of these, is provided for the image of the pole 208 in the second annotated image. The pole 208, however, is processed to the extent that it is determined that rays originating from a current viewpoint will intersect the pole 208 prior to encountering other objects in the scene. For example, with reference to the three-dimensional model top view 200, the ninth ray 268 encounters the pole 208 prior to other objects in the scene, and thus obscures other objects at that angle in the three-dimensional model such as parts of the second transformer 212.

The second annotated image 400 has a first bounding polygon 402 that indicates portions of the second transformer 212 that are visible in the second annotated image 400. As noted in the above discussed three-dimensional model top view 200, an image of the scene 202 from the second viewpoint 206 has the second transformer 212 partially obscured by the first transformer 210, the third transformer 214, and the pole 208. The second transformer 212 is indicated by a first bounding polygon 402 that is shown to conform around the edge of the first transformer 210, the third transformer 214, and the pole 208. In an example, the outline of the first bounding polygon 402 is determined by pixels in the image that correspond to rays extending from the second viewpoint “Y” 206 that intercept the first transformer 210, the third transformer 214, and the pole 208 without first intercepting the second transformer 212.

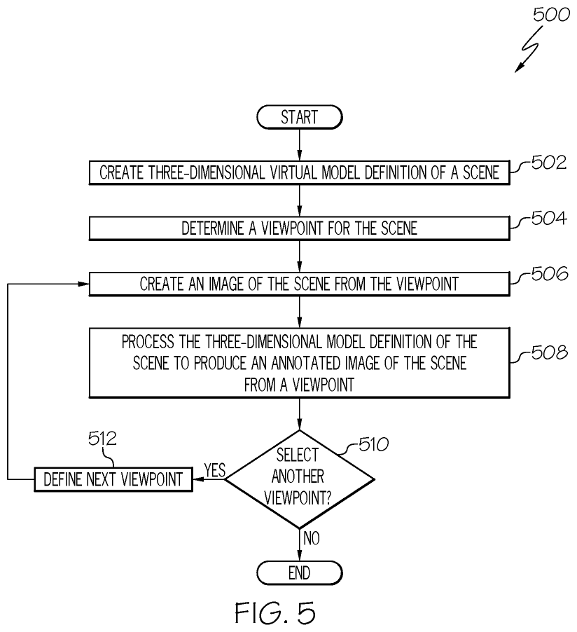

FIG. 5 illustrates an annotated image set generation process 500, according to an example. The annotated image set generation process 500 is an example of processing performed on a virtual three-dimensional model of a scene to create a number of images of that scene from a number of viewpoints. Annotations are also added to at least some images to indicate objects of interest, which are objects that machine learning based image recognition processes are to be trained to identify, that are at least partially visible in that image. In an example, the multiple images created by the image set generation process 500 are able to be included in a training corpus that is able to be used to train a machine learning based image recognition process to identify objects of interest in images.

The image set generation process 500 creates, at 502, a virtual three-dimensional model definition of a scene. Such a virtual three-dimensional model is able to be defined by any suitable technique. In an example, a scene is able to include electrical distribution equipment that is installed in various locations. An operator is able to define elements of such a scene, such as specifying the equipment included in the scene, the relative locations of each piece of such equipment relative to each other, and inclusion of other elements such as trees or other objects that are able to be in the vicinity of such a scene in real life.

An operator is able to define the scene and virtual three-dimensional representations of elements in that scene are used to define the three-dimensional model of that scene. In an example, a library of virtual three-dimensional representations of elements is maintained for objects that are able to be included in a scene definition. For example, one or more libraries may be maintained that include definitions of virtual three-dimensional representations of elements such as pole mounted electrical transformers, poles used by electrical utilities, other equipment used by electrical utilities, various types of trees or other vegetation, walls, other objects, or combinations of these. A scene is able to be defined in an example by an operator specifying a number of elements that are to be included in the scene, the three-dimensional location of each of those elements in the scene, any other information, or combinations of these. A virtual three-dimensional model definition of that scene is then generated in an example by appropriate software.

A viewpoint for the scene is determined, at 504. A viewpoint is a three-dimensional point that near the scene defined by the three-dimensional model and is a point from which an image of the scene is created. In general, a viewpoint is defined as a three-dimensional location in space relative to the scene and also an angle to be viewed from that location. In some examples, a viewpoint is determined only by a three-dimensional location relative to the scene to be captured and the angle to be viewed is assumed to be an angle that includes a view of the scene. The viewpoint is able to be determined by any suitable technique, such as through specification by an operator, by an automated technique that automatically determines a number of viewpoints in order to create a number of images of the scene from various viewpoints, by other techniques, or by combinations of these.

In some examples, an automated or semi-automated process is able to be used to create images of the scene from a number of different viewpoints. The specification of these different viewpoints is able to be defined in any suitable manner such as a specification of a progression of viewpoints around the scene, a specification of incremental changes to the location of the different viewpoints, other manners, or combinations of these.

An image of the scene from the viewpoint is created, at 506. This image in an example is created by processing of the three-dimensional model definition of the scene to create a two dimensional projection of the scene onto a plane at the determined viewpoint. Such an image is able to be created by any suitable technique.

The three-dimensional model definition of the scene is processed, at 508, to produce an annotated image of the scene from a viewpoint. Details of an example of such processing are described below. In an example, processing of the three-dimensional model includes performing a ray tracing analysis where virtual lines, or rays, are projected from the viewpoint at angle that intercept surfaces of the objects of interest in the virtual three-dimensional model. If a ray extends from the viewpoint to the object of interest without intercepting another object, the part of the object that the ray intercepts is determined by be visible and is included in an identification of that object in the created image. Such annotations, as discussed above, are able to include one or more of a bounding polygon, a label, other annotations, or combinations of these.

A determination is made, at 510, as to whether another viewpoint is to be selected. Such a determination is able to be based on, for example, an operator's input, processing a specification of a number of viewpoints for which images are to be created, other bases, or combinations of these.

If it is determined that another viewpoint is to be selected, the next viewpoint is defined, at 512. As discussed above, a number of viewpoint locations is able to be determined by autonomous or semi-autonomous techniques. In some examples, an operator is able to provide a definition of the next viewpoint. In general, the next viewpoint is able to be defined by any suitable technique. The image set generation process 500 then returns to creating an image of the scene from the new viewpoint, at 506.

Returning to determining, at 510, whether another viewpoint is to be selected, a determination that another viewpoint is not to be selected results in the image set generation process 500 ending.

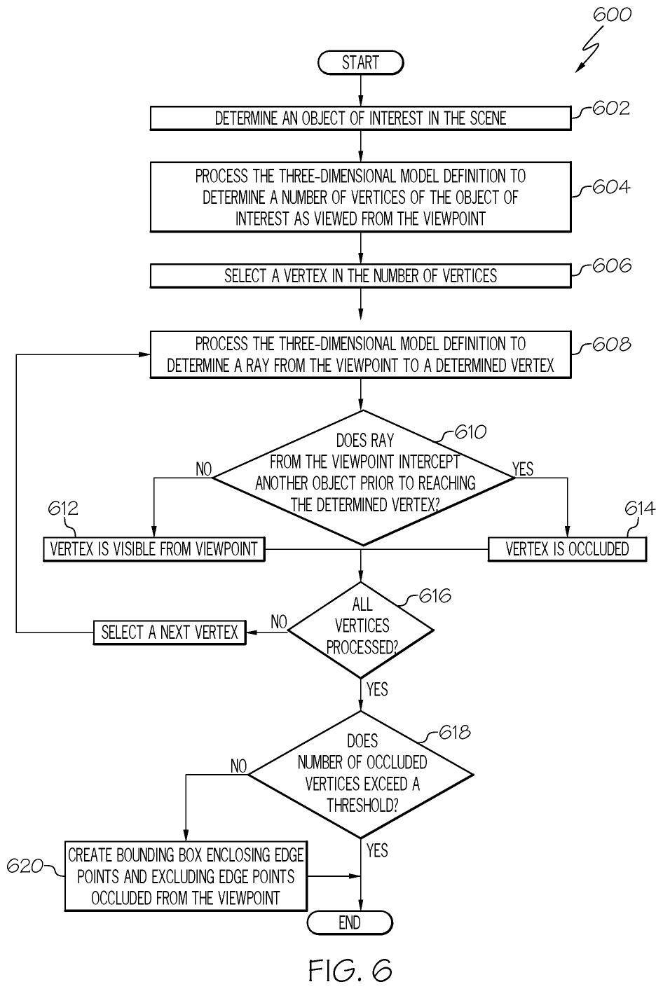

FIG. 6 illustrates a bounding polygon definition process 600, according to an example. The bounding polygon definition process 600 is an example of a process to provide annotation of an image that is created from a virtual three-dimensional model of a scene. The bounding polygon definition process 600 is an example of processing performed to process the three-dimensional model definition of the scene to produce an annotated image of the scene from a viewpoint, at 508, of the image set generation process 500.

The bounding polygon definition process 600 determines, at 602, an object of interest in the scene. Such an object is able to be determined by any suitable technique. In an example, creation of a virtual three-dimensional model includes specifying which objects in the scene are to be indicated in created images of that scene by various techniques. In an example, metadata associated with the virtual three-dimensional model indicates which virtual elements are objects of interest. The bounding polygon definition process 600 in an example annotates each processed image by sequentially processes each identified object of interest to properly annotate each object of interest in a scene that is captured by a particular image.

The virtual three-dimensional model definition is processed, at 604, to determine a number of vertices of the object of interest as viewed from the viewpoint. Vertices include edges of objects of interest such as the edge of the object as viewed from the viewpoint.

A vertex in the number of vertices is selected, at 606. In an example, the bounding polygon definition process 600 selects one vertex and sequentially processes each vertex that was determined for the object of interest.

The three-dimensional model definition is processed, at 608, to determine a ray from the viewpoint to a determined vertex. Such processing in an example includes determining an angle at which a ray originating from the viewpoint would intercept the selected vertex.

A determination is made, at 610, as to whether the ray from the viewpoint intercepts another object prior to reaching the vertex. In an example, such processing examines the virtual three-dimensional model of the scene to determine if there is a virtual object in the scene that the ray intercepts on its way from the viewpoint on to the object of interest prior to reaching a point on the object of interest.

If it is determined, at 610, that the ray did not intercept another object, the vertex is determined, at 612, to be visible from viewpoint. Such a determination results in that vertex being included in an area defined within a bounding polygon for the object of interest that is annotated on the image. If it is determined that the ray did intercept another object, the vertex is determined, at 614, to be occluded or obscured by that other object and thus the area defined by the bounding polygon will not include that vertex.

A determination is made, at 616, whether all vertices, as determined above at 604, have been processed. If it is determined that not all vertices for the object of interest have been processed, the bounding polygon definition process 600 selects, at 618, the next vertex in the determined vertices. The bounding polygon definition process 600 then continues to process, at 608, the three-dimensional model definition to determine a fry from the view point to the newly selected vertex.

Returning to the decision at 616, if it is determined that all vertices have been processed, the bounding polygon definition process 600 determines, at 620, if the number of occluded vertices exceeds a threshold. This determination in an example causes objects of interest that are mostly occluded in the view being processed from being annotated. The threshold is able to be determined by any suitable technique such as a based on the number of rays and their associated vertices, e.g., based on a percentage of the total number of vertices determined above, at 604, by techniques such as heuristic evaluations of such processing, by other techniques, or combinations of these.

If it is determined, at 620, that the number of occluded vertices does not exceed the threshold, a bounding polygon enclosing edge points and excluding edge points occluded from the viewpoint is created, at 622. After creating the bounding polygon, or determining that the number of occluded vertices exceeds the threshold, the bounding polygon definition process 600 ends.

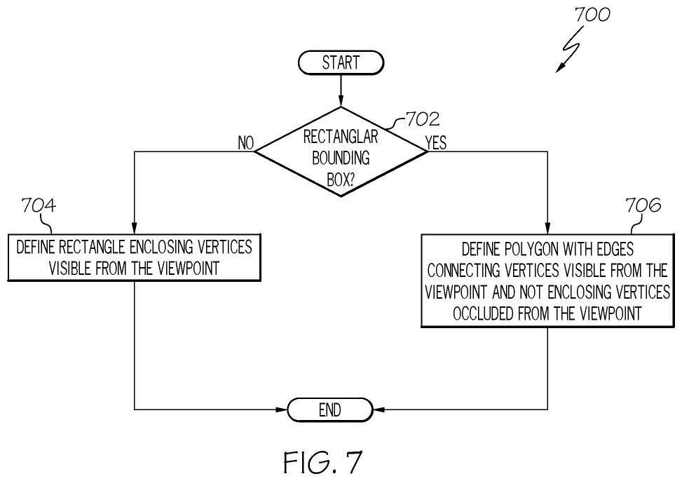

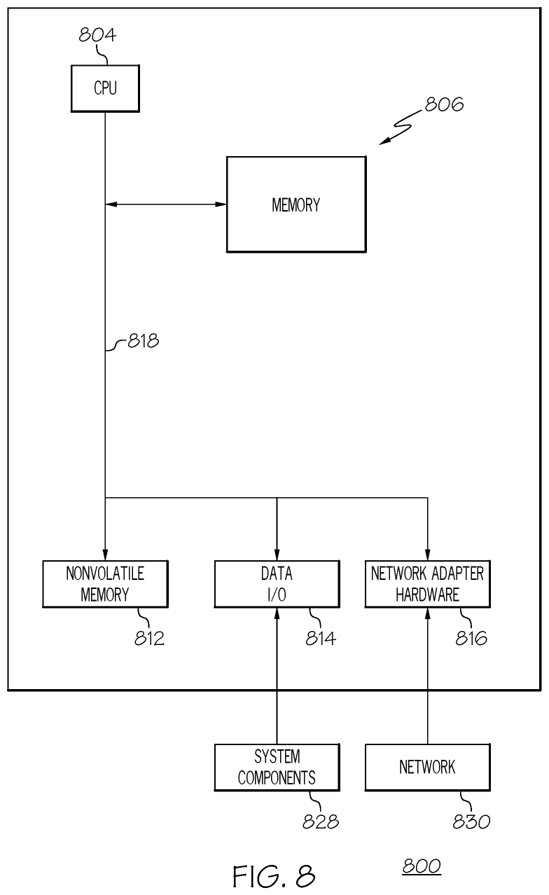

FIG. 7 illustrates a bounding polygon creation process 700, according to an example. The bounding polygon creation process 700 is an example of part of the process performed to create a bounding polygon enclosing visible vertices and excluding vertices that are occluded from the viewpoint, at 622, of the bounding polygon definition process 600.

The bounding polygon creation process 700 determines, at 702, if a rectangular bounding polygon is to be created. In some examples, an annotation of an image is able to indicate an object of interest by drawing a rectangular bounding polygon that encompasses the view of the object of interest in the image. This determination is able to be based on, for example, configuration of the processing to annotate images with rectangular bounding polygon, a specification by an operator, based on other things, or combinations of these.

If it is determined that a rectangular bounding polygon is to be created, a rectangle enclosing vertices visible from the viewpoint is created, at 704. In an example, such a bounding polygon is able to be created by specifying corners of the bounding polygon as coordinates in the image being processed. In various examples, creating a bounding polygon may or may not include modifying the image to add a visual representation of the bounding polygon. In some examples, coordinates of the bounding polygon in the image are able to be stored, such as in the form of metadata, with no modification to the image data of the image being processed.

Returning to the determination, at 702, in the case of a determination that a rectangular bounding polygon is not to be created, another form of bounding polygon is created. In an example, such a bounding polygon is able to include one or more polygons that that enclose the object of interest are able to be created. In an example, the bounding polygon creation process 700 defines, at 706, at least one polygon with edges connecting vertices visible from the viewpoint and not enclosing vertices occluded from the viewpoint. In an example, such a bounding polygon is able to outline an object of interest in a way that better conforms to the outline of the object of interest in the image.

In an image where the object of interest is partially occluded by another object, such polygons are able to be defined to outline the intersection of, or in other words a dividing line between, the image of the object of interest and the image of the object occluding the object of interest. Such bounding polygon provide more precise delineation of objects of interest within an image capturing a view of a scene. As discussed above, such bounding polygon in some examples are able to be defined as metadata and are not depicted by modification of the image.

After defining either a rectangular bounding polygon, or another type of bounding polygon, the bounding polygon creation process 700 ends.

FIG. 8 illustrates a block diagram illustrating a processor 800 according to an example. The processor 800 is an example of a processing subsystem that is able to perform any of the above described processing operations, control operations, other operations, or combinations of these.

The processor 800 in this example includes a CPU 804 that is communicatively connected to a main memory 806 (e.g., volatile memory), a non-volatile memory 812 to support processing operations. The CPU is further communicatively coupled to a network adapter hardware 816 to support input and output communications with external computing systems such as through the illustrated network 830.

The processor 800 further includes a data input/output (I/O) processor 814 that is able to be adapted to communicate with any type of equipment, such as the illustrated system components 828. The data input/output (I/O) processor in various examples is able to be configured to support any type of data communications connections including present day analog and/or digital techniques or via a future communications mechanism. A system bus 818 interconnects these system components.

### Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above described methods and realize the above described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A method to define a bounding polygon in a view of a three-dimensional scene, the method comprising:
defining a plurality of rays with each ray extending from a viewpoint of a virtual three-dimensional model to a respective vertex in a plurality of vertices of a virtual three-dimensional representation of an object of interest in the virtual three-dimensional model;
determining a set of occluded rays with respect to the object of interest in the plurality of rays, where each ray in the set of occluded rays intercepts a respective occluding object in the virtual three-dimensional model prior to reaching a respective vertex of the object of interest when extending from the viewpoint;
defining a set of visible rays with respect to the object of interest within the plurality of rays that excludes the occluded set of rays; and
defining, in an image of the virtual three-dimensional model that is created from the viewpoint, a bounding polygon for the object of interest that encompasses each vertex intercepted by the set of visible rays and excludes at least one vertex intercepted by a respective ray in the set of occluded rays.

2. The method of claim 1, further comprising:
defining a second plurality of rays with each ray extending from the viewpoint to a respective vertex in a second plurality of vertices of a virtual three-dimensional representation of the respective occluding object; and
determining, within the image based on the set of visible rays and the second plurality of rays, an edge dividing an image of the occluding object and an image of the object of interest,
wherein the bounding polygon comprises a side defined by the edge.

3. The method of claim 1, wherein the virtual three-dimensional representation of an object of interest comprises a representation of a damaged version of the object of interest.

4. The method of claim 1, wherein the bounding polygon comprises more than four sides.

5. The method of claim 1, wherein the bounding polygon comprises at least one side corresponding to a vertex of an occluding object in the virtual three-dimensional model.

6. The method of claim 1, further comprising determining that a number of vertices that are respective destinations of rays in the set of occluded rays is below a threshold, and
wherein defining the bounding polygon for the object of interest is based on determining that the number of vertices that are respective destinations of rays in the set of occluded rays is below the threshold.

7. The method of claim 6, wherein the threshold is based on a number of rays in the plurality of rays.

8. A system for defining a bounding polygon in a view of a three-dimensional scene the system comprising:
at least one processor;
a memory communicatively coupled to the processor;
wherein the at least one processor, when operating, is configured to:
define a plurality of rays with each ray extending from a viewpoint of a virtual three-dimensional model to a respective vertex in a plurality of vertices of a virtual three-dimensional representation of an object of interest in the virtual three-dimensional model;
determine a set of occluded rays in the plurality of rays, where each ray in the set of occluded rays intercepts a respective occluding object in the virtual three-dimensional model prior to reaching a respective vertex of the object of interest when extending from the viewpoint;
define a set of visible rays within the plurality of rays that excludes the occluded set of rays; and
define, in an image of the virtual three-dimensional model that is created from the viewpoint, a bounding polygon for the object of interest that encompasses each vertex intercepted by the set of visible rays and excludes at least one vertex intercepted by a respective ray in the set of occluded rays.

9. The system of claim 8, wherein the at least one processor, when operating, is further configured to:
define a second plurality of rays with each ray extending from the viewpoint to a respective vertex in a second plurality of vertices of a virtual three-dimensional representation of the respective occluding object; and
determine, within the image based on the set of visible rays and the second plurality of rays, an edge dividing an image of the occluding object and an image of the object of interest,
wherein the bounding polygon comprises a side defined by the edge.

10. The system of claim 8, wherein the virtual three-dimensional representation of an object of interest comprises a representation of a damaged version of the object of interest.

11. The system of claim 8, wherein the bounding polygon comprises more than four sides.

12. The system of claim 8, wherein the bounding polygon comprises at least one side corresponding to a vertex of an occluding object in the virtual three-dimensional model.

13. The system of claim 8, wherein the at least one processor, when operating, is further configured to:
determine that a number of vertices that are respective destinations of rays in the set of occluded rays is below a threshold, and
wherein defining the bounding polygon for the object of interest is based on determining that the number of vertices that are respective destinations of rays in the set of occluded rays is below the threshold.

14. The system of claim 13, wherein the threshold is based on a number of rays in the plurality of rays.

15. A computer program product for defining a bounding polygon in a view of a three-dimensional scene, the computer program product comprising a non-transitory computer readable medium storing instructions that, when executed, cause a processor to perform a method, the method comprising:
defining a plurality of rays with each ray extending from a viewpoint of a virtual three-dimensional model to a respective vertex in a plurality of vertices of a virtual three-dimensional representation of an object of interest in the virtual three-dimensional model;
determining a set of occluded rays in the plurality of rays, where each ray in the set of occluded rays intercepts a respective occluding object in the virtual three-dimensional model prior to reaching a respective vertex of the object of interest when extending from the viewpoint;
defining a set of rays visible within the plurality of rays that excludes the set of occluded rays; and
defining, in an image of the virtual three-dimensional model that is created from the viewpoint, a bounding polygon for the object of interest that encompasses each vertex intercepted by the set of visible rays and excludes at least one vertex intercepted by a respective ray in the set of occluded rays.

16. The computer program product of claim 15, wherein the method further comprises:
defining a second plurality of rays with each ray extending from the viewpoint to a respective vertex in a second plurality of vertices of a virtual three-dimensional representation of the respective occluding object,
determining, within the image based on the set of visible rays and the second plurality of rays, an edge dividing an image of the occluding object and an image of the object of interest,
wherein the bounding polygon comprises a side defined by the edge.

17. The computer program product of claim 15, wherein the virtual three-dimensional representation of an object of interest comprises a representation of a damaged version of the object of interest.

18. The computer program product of claim 15, wherein the bounding polygon comprises at least one side corresponding to a vertex of an occluding object in the virtual three-dimensional model.

19. The computer program product of claim 15, wherein the method further comprises:
determining that a number of vertices that are respective destinations of rays in the set of occluded rays is below a threshold, and
wherein defining the bounding polygon for the object of interest is based on determining that the number of vertices that are respective destinations of rays in the set of occluded rays is below the threshold.

20. The computer program product of claim 19, wherein the threshold is based on a number of rays in the plurality of rays.
